(19) United States
(12) Patent Application Publication
(10) Pub. No.: US 2020/0281375 A1
(43) Pub. Date: Sep. 10, 2020

(54) Commemorative Apparatus and Method

(71) Applicant: Rodney J. Poehler, Frankfort, OH (US)

(72) Inventor: Rodney J. Poehler, Frankfort, OH (US)

(21) Appl. No.: 16/808,965

(22) Filed: Mar. 4, 2020

Related U.S. Application Data
(60) Provisional application No. 62/816,169, filed on Mar. 10, 2019.

(51) Int. Cl. A47G 1/12; G09F 19/00; G09F 1/10

(52) U.S. Cl. CPC A47G 1/12; G09F 1/10; G09F 19/00

(57) ABSTRACT

A commemorative apparatus and method of using the same. The commemorative apparatus comprises a flexible body that is rollable. The commemorative apparatus further comprises an interior pocket and a securing component configured to secure the rolled body after a memento or keepsake is placed within the pocket. Once the commemorative apparatus is rolled and secured with the securing component, the memento is no longer visible. A method of using the commemorative apparatus is also disclosed.

### CROSS-REFERENCE

This application claims priority from Provisional Patent Application Ser. No. 62/816,169 filed on Mar. 10, 2019.

### BACKGROUND

The death of a friend or loved one is one of those events in life that few are emotionally prepared for as the situation can be extremely overwhelming. Remembering loved ones when they pass away can be difficult. People may be distraught and emotionally drained when trying to organize funeral and memorial events. Close friends and family may lack the time and energy to properly grieve. People may be unable to deliver messages and mementos to their loved ones in a discrete and timely manner.

It is common to send flowers, cards, statuary, pictures, or even make donations on behalf of the deceased. Ceremonies often include pictorial displays such as photographs or movies of the loved one as a way to remember and honor the deceased. However, these displays are public and visible to everyone attending the ceremony. Funeral rites, Masses, internments, and viewings are typically public, even if just limited to family. Grieving individuals, especially a spouse or parent, often have memories or mementos that they would like to use or give, but that might embarrass the griever when they are most vulnerable. Additionally, some individuals just prefer a private way to express their love and grief without the attention of others.

Accordingly, there is a great need for a way to provide users with a way to privately provide a memento or keepsake for a deceased family member or friend. The present invention allows users to express a heartfelt message to the recently deceased while attending a funeral or memorial service, thereby aiding in relieving stress and expressing emotions of the griever in the vulnerable time after a loved one passes away. The present invention offers a unique apparatus and method of using the apparatus to display love and friendship in the event of the death of a loved one allowing the griever to express themselves privately while remembering and honoring the deceased.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a commemorative apparatus for retaining a memento. The commemorative apparatus comprises a body, a memento retaining component, and a securing component. The body comprises an interior surface and an exterior surface. The memento retaining component is configured to define at least one pocket and comprises a plurality of sealed edges and an open edge. Each of the plurality of sealed edges are sealed or otherwise secured to the interior surface of the body. The securing component comprises a fastener such as a button and a string attached to the body. Once the commemorative apparatus is rolled up to encapsulate the memento, the string is wound around body and the button to seal the commemorative apparatus in a wrapped configuration.

The open edge of the memento retaining component may further comprise a retaining element. The retaining element is configured to at least partially close the open edge of the memento retaining component. The at least one pocket may be a plurality of pockets configured to accept a plurality of mementos. The exterior surface of the body may further comprise a decorative element.

In an additional embodiment of the present invention a method for retaining a commemorative memento comprises providing a memento and placing the memento within a memento retaining component of a commemorative apparatus. The method further comprises rolling up a body of the commemorative apparatus once the memento is retained within the memento retaining component. Once rolled, the memento is no longer visible. The method further comprises securing the commemorative apparatus once rolled with a securing component.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates an overhead view of a commemorative apparatus in accordance with the disclosed architecture.

FIG. 2 illustrates a perspective view of an interior surface of a body and a memento retaining component of the commemorative apparatus in accordance with the disclosed architecture.

FIG. 3 illustrates a top view of an exterior surface of the body of the commemorative apparatus in accordance with the disclosed architecture.

FIG. 4 illustrates a perspective view of the commemorative apparatus in a rolled up configuration secured by a securing component in accordance with the disclosed architecture.

FIG. 5A illustrates an overhead plan view of the commemorative apparatus in accordance with the disclosed architecture.

FIG. 5B illustrates a side plan view of the commemorative apparatus in accordance with the disclosed architecture.

FIG. 6 illustrates a perspective view of a commemorative apparatus comprising a memento retaining component comprising a plurality of pockets in accordance with the disclosed architecture.

FIG. 7 illustrates a flowchart of a method for retaining a commemorative memento in a commemorative apparatus in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a unique commemorative apparatus and method of using the same. The commemorative apparatus may be a commemorative cloth capable of being wrapped up to hold a memento or keepsake of a deceased family member or friend. Effectively the cloth allows a user to express a message to the recently deceased while attending a funeral or other memorial ceremony.

The cloth may utilize a string and button fastening combination to secure the cloth in the rolled orientation, thus securing the memento, such as a letter, picture, or other personal item within the cloth. The fabric cloth is designed to function as a memorial gift for the deceased loved ones. The cloth features an inner flap, a string, and a button, allowing the cloth to be rolled up and secured. Users can store a commemorative item inside the rolled-up cloth to recognize a friend or family member. The object may be placed within the inner flap and then rolled up to be concealed from others. The commemorative cloth may be constructed from nylon, cotton, fabric, and other suitable cloth materials. The exact size, measurement, construction, and design specifications may vary upon manufacturing based on the needs and requirements of the user.

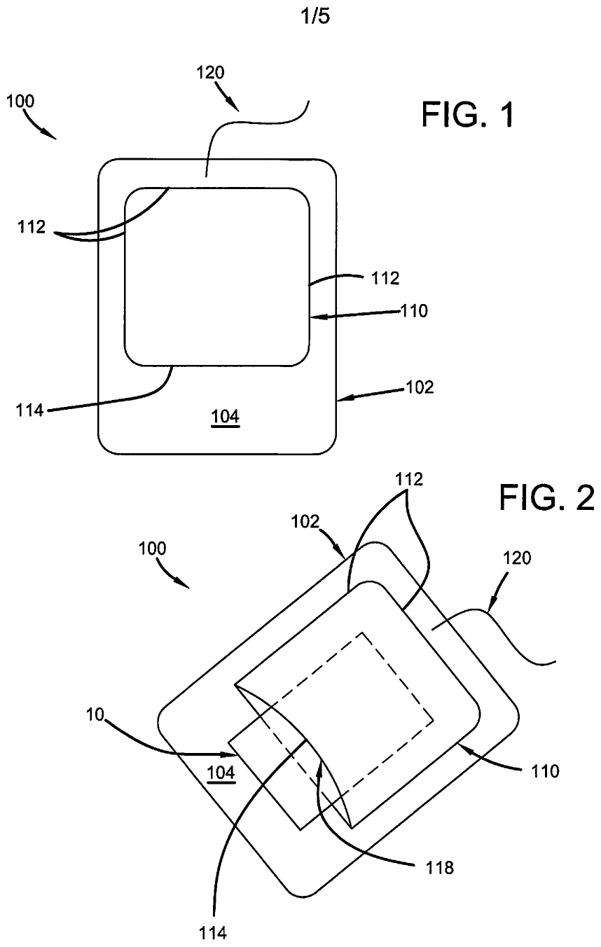

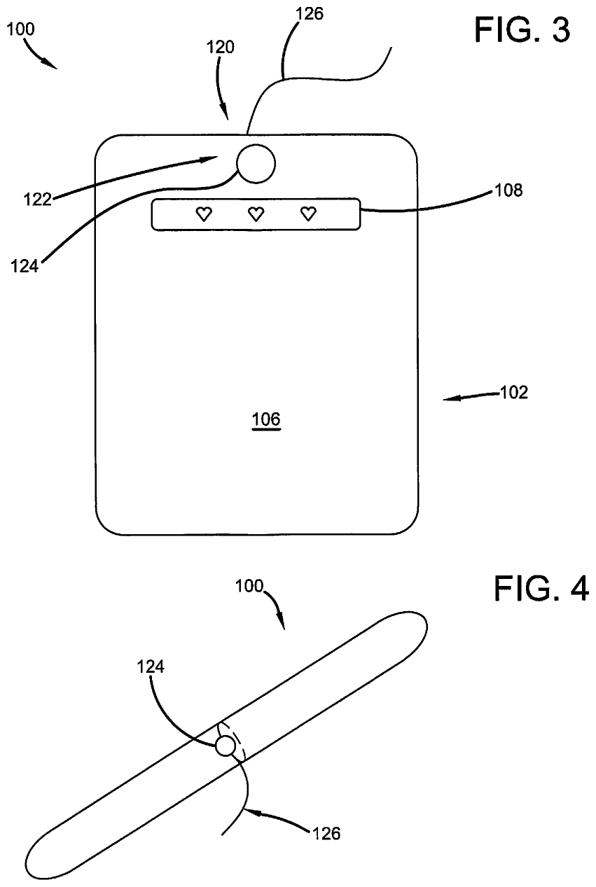

Referring initially to FIGS. 1-3, a commemorative apparatus 100 for retaining a memento 10 comprises a body 102. The body 102 comprises an exterior surface 106 as illustrated in FIG. 3, and an interior surface 104 as illustrated in FIGS. 1 and 2. The memento 10 may be a photograph, a written communication such as a letter, an object, a tangible reminder of someone or something, or any combination thereof. In one example, the memento 10 may be related to a recently deceased loved one such as a cherished photograph or letter expressing a lifetime of affection. However, the memento 10 could also relate to a living person, such as an object to be hidden for a later date. In another example, the memento 10 could be related to the birth of a child, such as a letter written by a new parent to a child for a later milestone such as a wedding or 18^{th} birthday.

The body 102 is typically manufactured from a fabric material or cloth, such as cotton, polyester, or nylon, but may be also manufactured from any other flexible material as well. Additionally, the exterior surface 106 may have a water resistant or weatherproof quality, such as a coating or spray on layer as desired. As illustrated in FIG. 3, the exterior surface 106 may comprise a decorative element 108. The decorative element 108 may be an inscription, an image, a design, or any other type of marking that is at least partially visible when the body 102 of the commemorative apparatus 100 is rolled up to encase the memento 10 as illustrated in FIG. 4. Additionally, the entire exterior surface 106 may be decorated as desired.

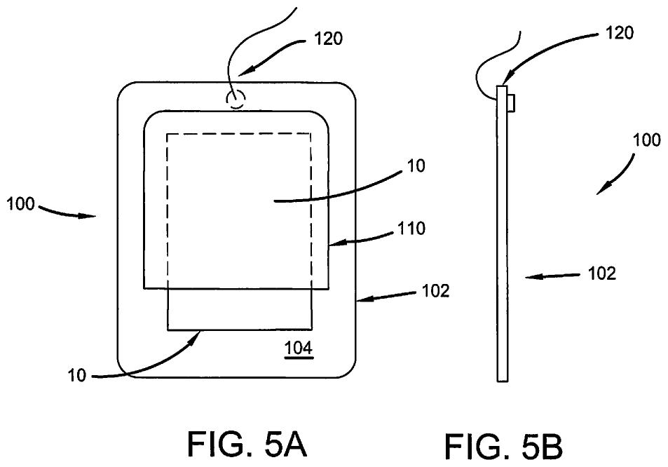

As further illustrated in FIGS. 5A and 5B, the commemorative apparatus 100 further comprises a memento retaining component 110 attached to the interior surface 104 of the body 102. The memento retaining component 110 comprises a plurality of sealed edges 112 and an open edge 114. The plurality of sealed edges 112 are sealed, stitched, sewn, adhered, or otherwise attached to the interior surface 104 of the body 102. The plurality of sealed edges 112 and the open edge 114 of the memento retaining component 110 are configured to define a pocket 118 for accepting and retaining the memento 10 within the commemorative apparatus 100. The open edge 114 may comprise a retaining element (not shown), such as a snap or button, to at least partially close the open edge 114 once the memento 10 is placed in the pocket 118. The memento retaining component 110 may be manufactured from similar materials as the body 102 or may be manufactured from transparent or translucent materials so that the retained memento 10 may be visible through the material when the commemorative apparatus 100 is in an unrolled configuration.

The commemorative apparatus 100 further comprises a securing component 120. The securing component 120 is typically attached to the body 102 but may also be detached or partially detached as well. The securing component 120 comprises a fastener 122. The fastener 122 is typically a button 124 and a string 126 or cord, but may be a snap/button combination, a clasp system, or any other type of fastener as is known to one of ordinary skill in the art. In one embodiment, the button 124 is attached to the exterior surface 106 of the body 102 and the string 126 is attached to the interior surface 104. However, the button 124 and the string 126 may be attached to the same surface or the body 102 as desired.

Once the memento 10 is placed in the pocket 118, the body 102 is wrapped or rolled up so that the interior surface 104 and the memento retaining component 110 are encapsulated within the commemorative apparatus 100 as illustrated in FIG. 4. In the wrapped configuration, the memento 10 is no longer visible providing privacy for the user. Once the commemorative apparatus 100 is rolled up, the body 102 is secured by wrapping the string 126 around the body 102 and the button 124.

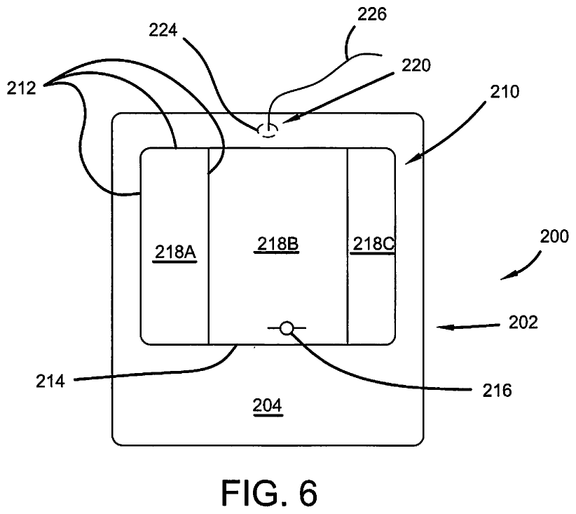

In an additional embodiment illustrated in FIG. 6, a commemorative apparatus 200 for retaining a memento 10 comprises a body 202. The body 202 comprises an exterior surface (similar to 106) and an interior surface 204. The memento 10 may be a photograph, a written communication, an object, a tangible reminder of someone or something, or any combination thereof as discussed supra.

The body 202 is typically manufactured from a fabric material or cloth, such as cotton or nylon, but may be also manufactured from any flexible material as well. Additionally, the exterior surface (not shown) may have a water resistant or weatherproof quality, such as a coating or spray on layer as desired. The exterior surface (not shown) may comprise a decorative element (not shown). The decorative element (not shown) may be an inscription, an image, a design, or any other type of marking that is at least partially visible when the body 202 of the commemorative apparatus 200 is rolled up to encase the memento 10 as discussed supra. Additionally, the entire exterior surface (not shown) may be decorated as desired.

The commemorative apparatus 200 further comprises a memento retaining component 210 attached to the interior surface 204 of the body 202. The memento retaining component 210 comprises a plurality of sealed edges 212 and an open edge 214. The plurality of sealed edges 212 are sealed, stitched, sewn, adhered, or otherwise attached to the interior surface 204 of the body 202. The plurality of sealed edges 212 and the open edge 214 of the memento retaining component 210 are configured to define at least one pocket 218A for accepting and retaining the memento 10 within the commemorative apparatus 200. The open edge 214 may comprise a retaining element 216, such as a snap or button, to at least partially close the open edge 214 once the memento 10 is placed in the at least one pocket 118A.

The at least one pocket 218A may be a plurality of pockets 118A-C. The plurality of pockets 218A-C may be of any size or configuration as desired to accept multiple different sized mementos. For example, a photograph, a note, and a wedding ring could all be placed in the plurality of pockets 218A-C. The memento retaining component 210 may be manufactured from similar materials as the body 202 or may be at least partially transparent and manufactured from transparent or translucent materials so that the retained memento 10 may be visible through the material.

The commemorative apparatus 200 further comprises a securing component 220. The securing component 220 is typically attached to the body 202 but may also be detached or partially detached as well. The securing component 220 comprises a fastener (similar to 122). The fastener is typically a button 224 and a string 226 or cord, but may be a snap/button combination, a clasp system, or any other type of fastener as known to one of skill in the art. In one embodiment, the button 224 is attached to the exterior surface (not shown) of the body 202 and the string 226 is attached to the interior surface 204. However, the button 224 and the string 226 may be attached to the same surface or the body 202 as desired.

Once the memento 10 is placed in the at least one pocket 218A-C, the body 202 is wrapped or rolled up so that the interior surface 204 and the memento retaining component 210 are encapsulated within the commemorative apparatus 200. In the wrapped configuration, the memento 10 is no longer visible providing privacy for the user. Once the commemorative apparatus 200 is rolled up, the body 202 is secured by wrapping the string 226 around the body 202 and the button 224.

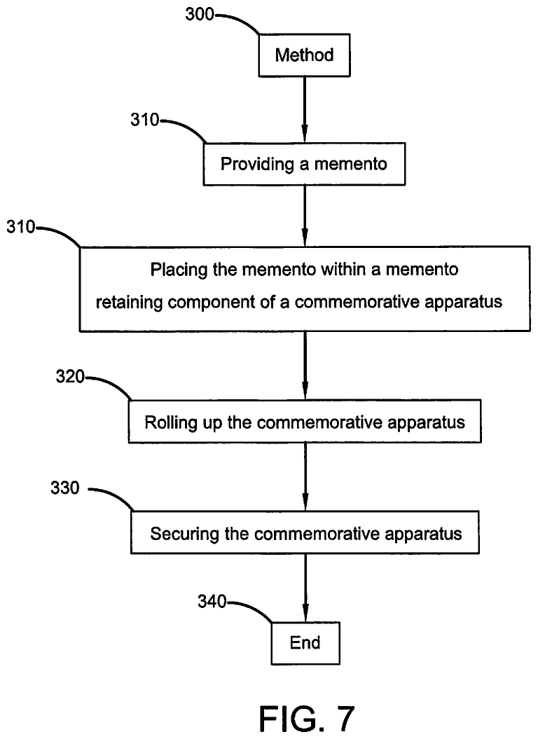

FIG. 7 illustrates a flowchart of a method 300 for retaining a commemorative memento 10 in a commemorative apparatus 100. The method 300 begins at 310 by providing the memento 10 to be secured. At 320, a user places the memento 10 within a pocket 118 of the memento retaining component 110 of the commemorative apparatus 100. Next at 330, the user rolls up a body 102 of the commemorative apparatus 100 so that the memento 10 retained within the memento retaining component 110 is encapsulated within the body 102 and is no longer visible. At 340, the rolled up commemorative apparatus 100 is secured with a securing component 120, such as a button 124 and string 126 combination as discussed supra. The method 300 then ends at 350 with the memento 10 secured within the commemorative apparatus 100.

Notwithstanding the forgoing, it is also contemplated that commemorative apparatus 100 can be used in other settings as well, such as wedding shops, boutiques, schools, social groups, and anywhere that sharing emotions can be difficult. Stated differently, it should be appreciated that a key objective of commemorative apparatus 100 is that it enables individuals to share their emotions, experiences and thoughts with a loved one, a friend or acquaintance in a very private, tasteful and classy manner.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A commemorative apparatus for retaining a memento comprising:
a body comprising an interior surface and an exterior surface;
a memento retaining component attached to the interior surface of the body; and
a securing component attached to the body.

2. The commemorative apparatus of claim 1, wherein the body is manufactured from a fabric material.

3. The commemorative apparatus of claim 1, wherein the exterior surface of the body is water resistant.

4. The commemorative apparatus of claim 1, wherein the exterior surface comprises a decorative element.

5. The commemorative apparatus of claim 4, wherein the decorative element is an inscription.

6. The commemorative apparatus of claim 1, wherein the memento retaining component is transparent.

7. The commemorative apparatus of claim 1, wherein the memento retaining component comprises a plurality of edges sealed to the interior surface of the body.

8. The commemorative apparatus of claim 1, wherein the memento retaining component comprises an open edge.

9. The commemorative apparatus of claim 1, wherein the body is wrapable to encapsulate the memento retaining component.

10. The commemorative apparatus of claim 1, wherein the securing component comprises a fastener.

11. The commemorative apparatus of claim 1, wherein the securing component comprises a button and a string.

12. A commemorative apparatus for retaining a memento comprising:
a body comprising an interior surface and an exterior surface;
a memento retaining component attached to the interior surface of the body, the memento retaining component configured to define at least one pocket; and
a securing component attached to the body.

13. The commemorative apparatus of claim 12, wherein the memento retaining component is at least partially transparent.

14. The commemorative apparatus of claim 12, wherein the memento retaining component comprises a plurality of edges sealed to the interior of the body and an open edge to accept the memento.

15. The commemorative apparatus of claim 14, wherein the memento retaining component comprises a retaining element for at least partially closing the open edge.

16. The commemorative apparatus of claim 12, wherein the securing component comprises a button and a string.

17. The commemorative apparatus of claim 12, wherein the memento is not visible when the body of the commemorative apparatus is secured with the securing component.

18. A method for retaining a commemorative memento, the method comprising:
providing a memento;
placing the memento within a memento retaining component of a commemorative apparatus;
rolling up a body of the commemorative apparatus so that the memento is no longer visible; and
securing the commemorative apparatus with a securing component.

19. The method of claim 18, wherein the memento retaining component defines a pocket.

20. The method of claim 17, wherein the securing component comprises a button and a string.
